(19) United States
(12) Patent Application Publication
(10) Pub. No.: US 2004/0176158 A1
(43) Pub. Date: Sep. 9, 2004

(54) Lottery ticket, lottery system and methods of use

(76) Inventor: Gary G. Baldwin, Boulder City, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/731,326

(22) Filed: Dec. 8, 2003

Related U.S. Application Data
(60) Provisional application No. 60/436,449, filed on Dec. 27, 2002.
(60) Provisional application No. 60/436,458, filed on Dec. 27, 2002.

(51) Int. Cl. A63F 13/00

(52) U.S. Cl. 463/17

(57) ABSTRACT

A scratch off lottery ticket comprising a casino sponsor. A first ticket portion is dedicated to a game of chance traditionally found on scratch off lottery tickets. A second ticket portion is dedicated to prizes associated with the casino sponsor. Prizes include free casino play, drawing entries and discounted casino amenities. Prizes are redeemed at the casino location thereby increasing casino traffic. Any free play may be redeemed by inserting the winning ticket into a game device at the casino location. The ticket is a marketing tool for both the lottery and casino. A lottery may also sponsor an entire ticket and offer game credits redeemable on game devices provided by the lottery. Play of the game devices is tracked so that players accumulate points which are redeemed for lottery supplied merchandise. Winning and non winning lottery tickets may also facilitate bonus play of corresponding game devices.

### CROSS REFERENCE TO RELATED APPLICATIONS

This application claims the benefit of U.S. Provisional Application No. 60/436,449 filed Dec. 27, 2002 and U.S. Provisional Application No. 60/436,458 filed Dec. 27, 2002.

### FIELD OF THE INVENTION

The present invention relates to lotteries and casinos. More particularly, online and scratch off lottery tickets redeemed and played in combination with casino games, game devices, video lottery terminals and non casino game devices sponsored and marketed by both lotteries and casinos.

### BACKGROUND

The popularity of legalized gaming has become so prolific that nearly every state has some form of state sponsored gaming. Many states have implemented state sponsored lotteries which comprise both live events (e.g., Power Ball and Mega Millions) and scratch off lottery tickets. The live events consist of regularly scheduled random drawings. With respect to the live drawings, players purchase online tickets requiring each player to select specific player numbers (or a lottery machine may select random player numbers for a player) prior to the random drawing in an attempt to match one or more of the player numbers with the randomly drawn numbers. Payouts are based on the number of matched numbers. Contrarily, scratch off tickets offer instant gratification and typically include a ticket having certain game information concealed by a removable opaque material (e.g., latex). Upon purchase, the player reveals the concealed game information by removing or scratching off the applied latex material. The revealed game information provides the basis for awarding a prize, if any.

There are billions of online and scratch off tickets printed for U.S. lotteries annually. Prices for the tickets can range from $1 to $20. Thirty eight states and the District of Columbia currently offer online and/or instant games of chance in the form of scratch off tickets. Undoubtedly, this number will grow as the U.S. population continues to crave entertainment in the form of gambling.

To date, state lotteries have promoted online and scratch off tickets through themes and monetary prize schemes. For example, Gold Strike and Red Hot Sevens are just two themes used by the California lottery to promote its scratch off tickets. Also, California distributes scratch-off lottery tickets with large instant prizes (e.g., $5,000). Online ticket sales are driven by substantial monetary awards (e.g., $1,000,000).

While online and scratch off tickets continue to be popular, there continues to be the need for new and exciting opportunities for the players of online and scratch off tickets. To that end, industries in collaboration with the state lotteries offer both a unique ticket design and unique dynamic marketing scheme for enticing players to continue their purchase of online and scratch off tickets. For example, a state scratch off ticket may offer prizes, such as free play or discounts, related to the casino industry. The casino industry is particular suitable given the willingness and/or propensity of online and scratch off ticket purchasers to gamble. However, other industries are also suitable. In a first casino embodiment, a casino sponsors a portion of a scratch off ticket and offers certain casino related prizes in conjunction with a separate state lottery portion of the ticket. The collaboration of the state lottery and private industry creates a unique marketing arrangement which benefits both the state lottery and the sponsoring industry.

In another embodiment, lottery tickets include a section for awarding game device credits. In this embodiment, a state lottery or casino operates a network of game devices or stand alone game devices which include means for receiving, acquiring and processing data on said online and scratch off lottery tickets. Once the data is read, game device credits or bonus play are credited to the device. Ideally, the means comprises a bar code reader or optical reader integrated within the game device for reading a bar code or other identifying mark on said lottery ticket. However, other means, including manual entry, may accomplish the same objective. The lottery or casino system further includes a player tracking feature which tracks play of the game devices whereby players accumulate points or credits based on play or the outcome of the game. The points or credits are then redeemed for prizes or cash.

### SUMMARY

Accordingly, a first embodiment of the present invention comprises a scratch off lottery ticket having a lottery sponsored portion and industry sponsored portion. While industries other than casinos may benefit from the first embodiment of the present invention, for the sake of brevity, casinos are used throughout this document to describe the embodiments of the present invention. The scratch off lottery ticket includes an upper lottery sponsored portion and lower casino sponsored portion. The lottery sponsored portion is designed and managed by the lottery offering the ticket. The casino portion is designed pursuant to prizes being offered by the casino sponsor.

In one embodiment, the casino portion of the ticket comprises a Winners Circle, Players Circle and Stay-n-Play section. The Winners Circle is dedicated to offering entries to drawings for substantial cash prizes and/or significant merchandise awards. The Players Circle is dedicated to offering free game device play at the sponsor casino. The Stay-n-Play section provides room discounts and similar discounts to be redeemed at the sponsor casino.

The prizes offered pursuant to the Winners Circle, Players Circle and Stay-n-Play features of the ticket are ultimately determined by the sponsor casino. Ideally, as described above, the Winners Circle offers entries to specific drawings held at the sponsor casino location and require participants to redeem the entry at the casino. The prizes offered pursuant to the Winners Circle should be substantial to encourage player redemption of the entries. Ideally, the Players Circle offers free gaming at the sponsor casino. For example, a player may win $1000 of free slot machine play to be redeemed at the sponsor casino. The Stay-n-Play section is dedicated to awarding discounts for rooms, merchandise, shows and other services or goods offered by the sponsor casino.

Obviously, alternative ticket designs are possible as they relate to casinos. That is, the Winners Circle, Players Circle and Stay-n-Play sections are illustrative of the infinite number of designs and schemes possible by combining a traditional scratch off lottery ticket with a casino sponsor.

In a second embodiment, a scratch off lottery ticket comprises a first traditional game section and a second section dedicated to awarding game device credits. The number of game device credits awarded by a ticket is revealed upon removal of the latex coating and is also encrypted in a bar code on the ticket. The game credits may also be placed on a voucher attached to the scratch-off lottery ticket. In the voucher arrangement, the voucher is placed in a pouch integrally sealed to the ticket. The pouch ticket is well-known in the lottery industry. In this embodiment, the game devices are designed to accept and read winning scratch off lottery tickets and vouchers. Upon reading the bar code, the credits are automatically placed on the game device for player play. A player tracking system tracks play and awards points based on said play. Accumulated points are then redeemed for lottery prizes.

In a third embodiment, an online pouched or scratch off lottery ticket is used to participate in a bonus game offered by the sponsoring casino. The bonus game may be in communication with a linked game device or may be facilitated by an independent game device.

### BRIEF DESCRIPTION OF THE DRAWINGS

FIG. 1 shows a front of a scratch off ticket pursuant to a first embodiment of the present invention;

FIG. 2 shows the front of the scratch off ticket having an upper lottery portion revealed;

FIG. 3 shows the front of the scratch off ticket having a Winners Circle revealed;

FIG. 4 shows the front of the scratch off ticket having a Players Circle revealed;

FIG. 5 shows the front of the scratch off ticket having a Stay-n-Play revealed;

FIG. 6 shows the back of the scratch off ticket of the first embodiment;

FIG. 7 shows a scratch off ticket design pursuant to a second embodiment of the present invention;

FIG. 8 shows a network of game prize devices pursuant to the second embodiment of the present invention;

FIG. 9 shows a block diagram of a fulfillment network pursuant to the second embodiment of the present invention; and

FIG. 10 shows an online ticket design pursuant to a third embodiment of the present invention.

### DETAILED DESCRIPTION

Online and scratch off lottery tickets are well known in the industry and are not described in great detail herein. Generally, online tickets are printed on cash register like receipt paper and scratch off tickets are printed on sturdy paper or cardboard and include printed game areas coated by an opaque removable material, such as latex. By removing the latex material (i.e., scratching off) game outcomes are revealed. Removing the material is typically accomplished by using a coin, key or similar rigid item. The revealed game outcomes are the basis for a corresponding prize, if any.

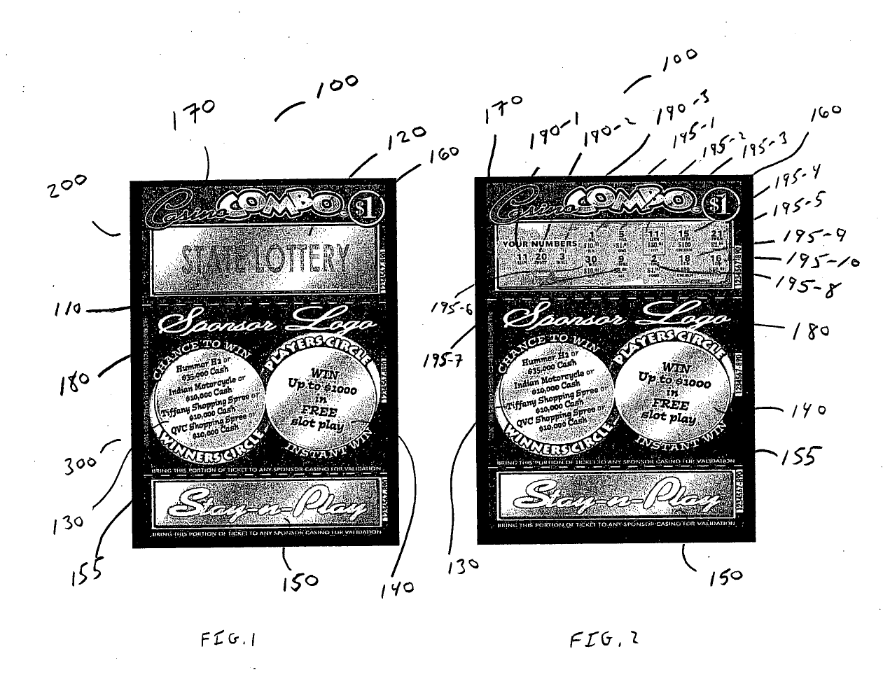

Reference is now made to the figures wherein like parts are referred to by like numerals throughout. FIG. 1 illustrates a front of a scratch off ticket pursuant to a first embodiment of the present invention and is generally referred to by reference numeral 100. The lottery ticket 100 consists of a lottery portion 200 and a casino sponsored portion 300. The two distinct portions 200 and 300 may be separated by a perforation 110 therebetween. The perforation 110 provides a means for permanently separating the lottery portion 200 and the casino sponsored portion 300 for reasons which will become evident below.

In the first embodiment, as shown in FIG. 1, the lottery portion 200 comprises a single latex coated game area 120 and the casino sponsored portion comprises a Winners Circle 130, Players Circle 140 and Stay-n-Play area 150. A perforation 155 allows the Stay-n-Play section to be separated from the remaining portion of the ticket 100. Other features include a ticket price 160, ticket name 170 and sponsor logo 180. The design of the sponsor logo 180 is used to identify and market the specific casino sponsor associated with the ticket 100.

Now referring to FIG. 2, the latex coating of game area 120 has been removed or scratched off to reveal a game outcome. The game shown is based on two sets of numbers. In order to win a prize, one or more numbers from a first set of player numbers 190 1 through 190 3 must match a number or numbers from a second set of game numbers 195 1 through 195 10. In FIG. 2, the winning prize is $30.00 based on the match of player number 190 1 and game number 195 3. It is apparent that any number of other games may be the subject of the lottery portion 200 of the ticket 100. The lottery portion 200 of the ticket 100 is designed and managed by the lottery offering the ticket 100.

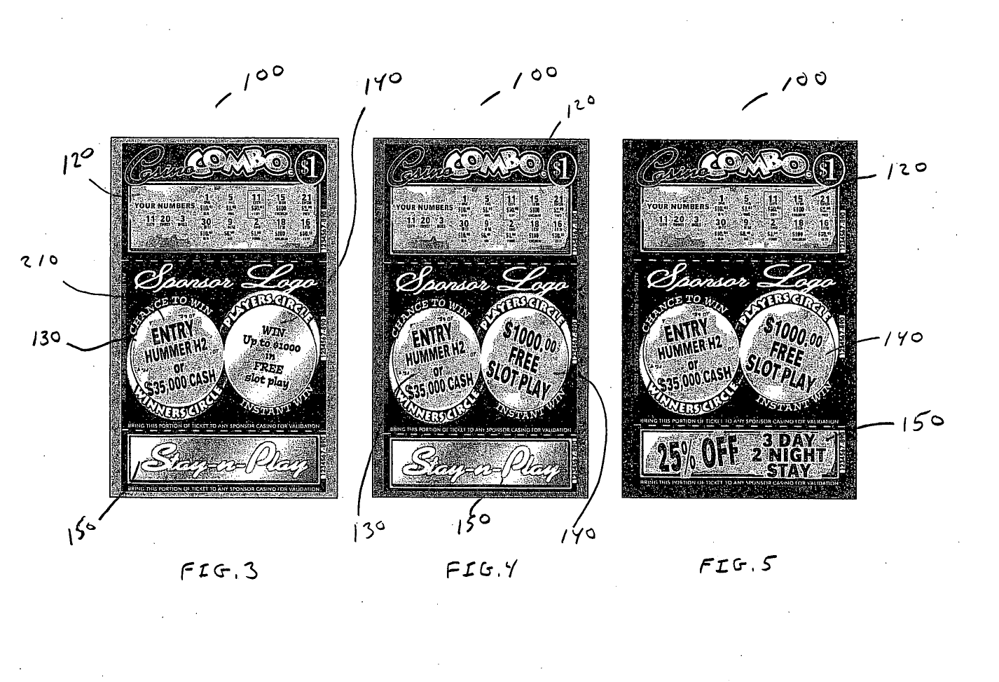

FIG. 3 shows the latex coating of the Winners Circle 130 removed. The Winners Circle 130 is dedicated to awarding entries into prize drawings. To encourage ticket purchases, the prize should be substantial, such as an automotive vehicle or cash equivalent. In FIG. 3, the entry 210 is for a Hummer H2 or $35,000 in cash. To win the prize, the sponsor may require that the ticket be redeemed for entry at the sponsor casino and/or require the individual to be present for the drawing. In this manner, the sponsor casino is providing the ticket purchaser with a legitimate incentive for frequenting the sponsor casino. This marketing scheme is ideal for promoting casinos located in the state offering the ticket 100. However, casino locations outside the state offering the tickets may also sponsor a lottery ticket in an effort to draw patrons from a specific state into its casino located in another state. The combinations are limited only by state and federal gaming laws.

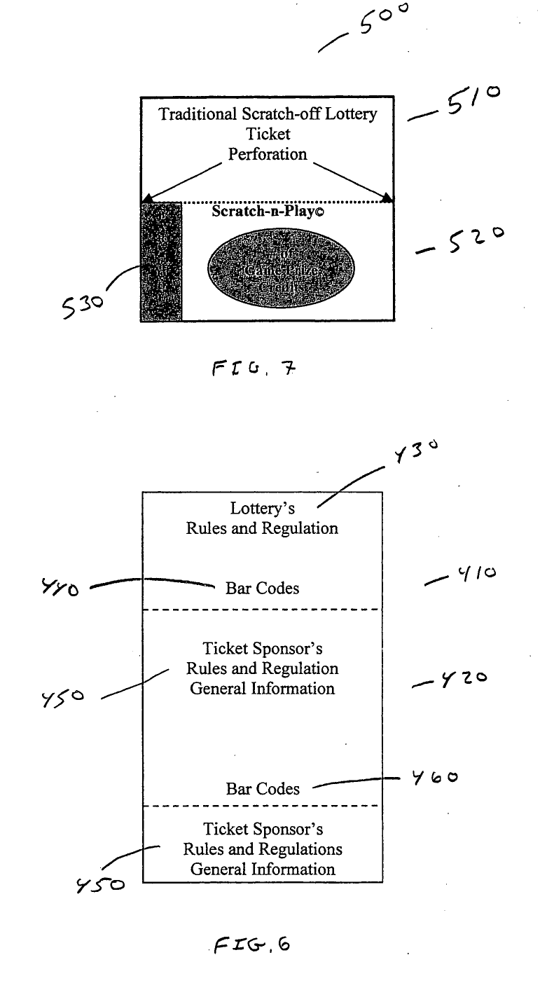

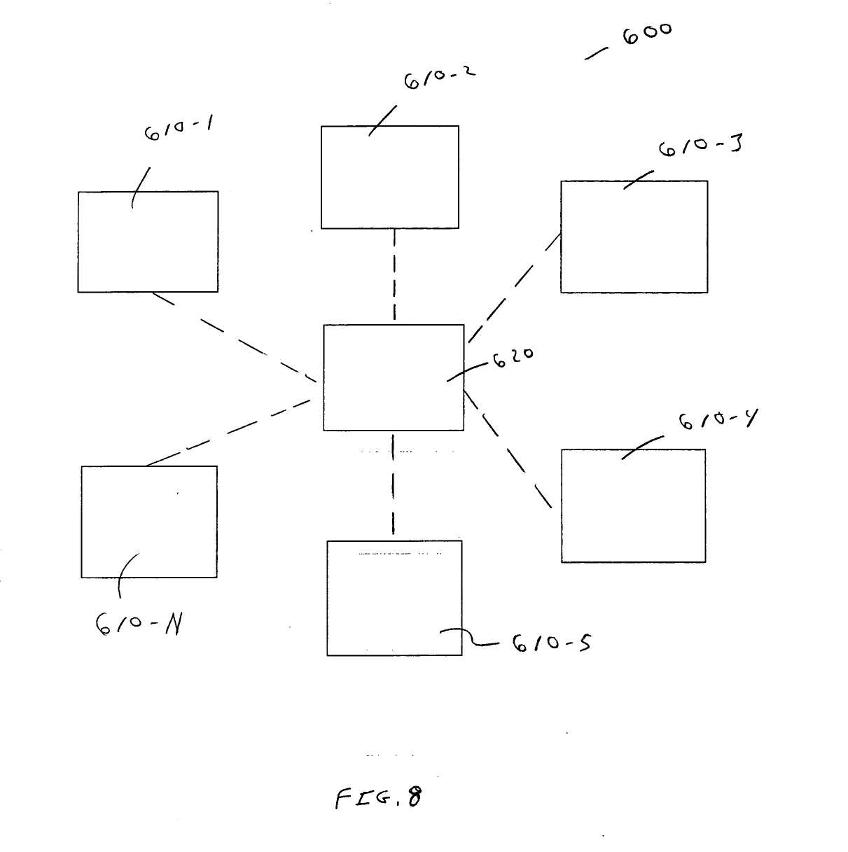

The Players Circle 140 is dedicated to prizes associated with free casino play. As shown in FIG. 4, the latex coating of the Players Circle 140 has been removed to reveal $1000 in free slot play. In a first embodiment, the free play is redeemed by inserting the scratch off ticket 100 into a bill or cashless ticket validator of a game device, such as a slot machine, video poker machine, keno machine or the like. A bar code 400 (shown in FIG. 6) is read by a bar code reader causing the free play to be credited to the game device. A device credit display provides the player with verification of the credited free play. As a prerequisite to collecting the free play the casino may require the player to join the casino's slot club. Once the player joins the slot club, the player is issued a player's card. The use of the card permits the casino to track the player's play and, based on the play or game outcomes, market casino amenities to the player. Such marketing efforts may include awarding comps, direct mailings, coupons for goods and services, etc. A majority of casinos now employ such systems or their equivalent.

In another embodiment, the free play is programmed directly into the casino player tracking system such that insertion of the corresponding player tracking card into a game device causes the tracking system to automatically place the free play credits onto a credit display of the game device selected by the player. The player is then able to play the device using the free credits.

Alternatively, the player may be issued a voucher for insertion into a game device bill or cashless validator. Markings on the voucher may identify it as a play only voucher such that the player may not take it to a cashier and redeem it for cash. The voucher includes a bar code readable by a bar code reader adjacent to the bill or cashless validator. Such cashless play is the trend in the casino industry.

FIG. 5 shows the scratch off ticket 100 having the latex coating of the Stay-n-Play section 150 removed. The revealed prize is a 25% discount on a 3 day/2 night stay at the sponsor casino. Although the revealed prize relates to a room discount, the sponsor casino may provide an unlimited number of different prizes, including discounted meals, entertainment and related casino amenities.

A back of the scratch off ticket 100 is shown in FIG. 6. The back comprises a lottery section 410 and casino sponsor section 420. The lottery section 410 includes lottery rules and regulations 430 and bar codes 440. The lottery bar codes 440 allow the lottery portion 200 of winning tickets to be easily redeemed and verified at pre established lottery locations. Lottery redemption locations have bar code readers designed to read the ticket bar codes 440. The casino sponsor section 420 includes casino rules and regulations 450 and bar codes 460. The casino bar codes 460 allow the casino portion 300 of winning tickets to be easily redeemed and verified at the sponsoring casino location. Again, the sponsoring casino location has a bar code reader for reading the bar codes 460. Also, the casino bar codes 460 may permit the casino portion 300 of the winning ticket to be inserted directly into a game device to redeem any free play. In this arrangement, the game device bill validator receives the winning ticket and the bar code reader adjacent thereto reads and verifies the amount of free play. Once the credits are made available to the player (e.g., placed on the credit display) the ticket is voided by the device. Alternatively, the device may retain the tickets which are periodically retrieved by casino personnel.

The benefits of the combination ticket described above are substantial. They include the ability for a lottery to differentiate their scratch off tickets from others while providing losing lottery players a second chance to win through the casino portion of the ticket. Obviously, casinos benefit by attracting additional patrons who desire to redeem Winners Circle, Players Circle and Stay-n-Play winnings. Retailers of the lottery tickets benefit by selling more tickets thereby increasing revenue.

While one scratch off ticket design has been illustrated in FIGS. 1-6, it should be understood that an infinite number of ticket designs are possible. In fact, each different state lottery may partner with a different casino and design entirely different tickets.

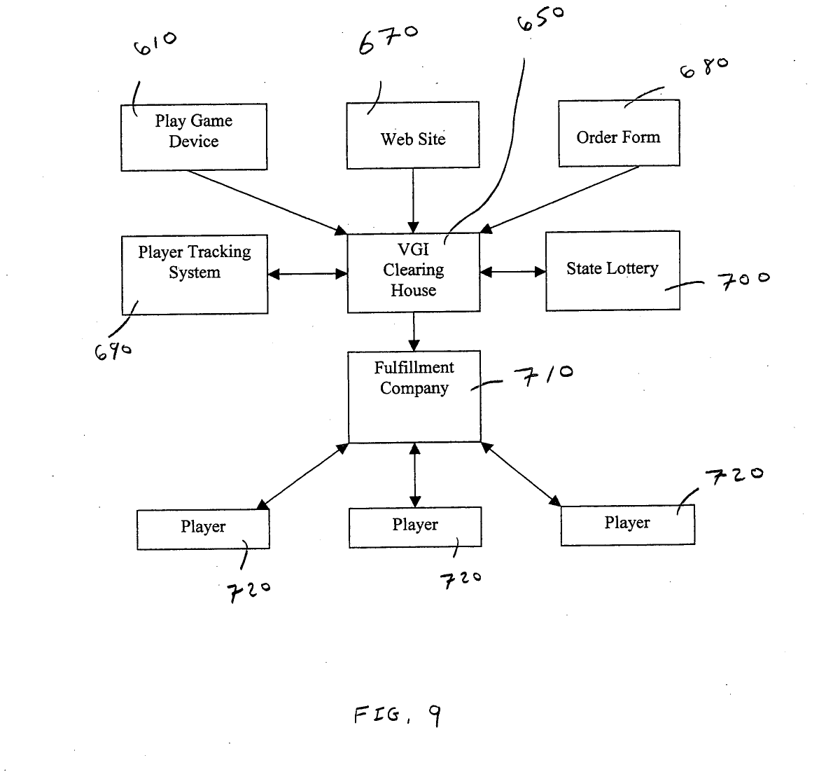

FIG. 7 shows an alternative scratch off ticket 500 designed for use with a game prize network 600 (shown in FIG. 8) and lottery loyalty program. The ticket 500 comprises a lottery portion 510 and a game prize credit portion 520. The game prize credit portion 520 includes a scratch off game dedicated to awarding game device credits. A bar code 530 provides a means for inserting the game prize credit portion 520 into a game prize device 610 (shown in FIG. 8). The game prize network 600 is a lottery operated system which connects a plurality of devices 610 1 through 610 N throughout a subject state or states to one or more central computers or servers 620.

The network 600, shown in FIG. 8, allows each game device 610 1 through 610 N to be monitored by lottery representatives from one or more centralized locations. In one embodiment, the network 600 is comprised of multiple local area networks (LANs) linked together to form a Wide Area Network (WAN). Available technology and future technological advances provide the means for creating and operating the network 600 as determined ultimately by the lottery.

Each game prize device 610 1 through 610 N includes a ticket receiver for accepting the game prize credit portion 520 of the ticket 500. A bar code reader integrated adjacent to the ticket receiver reads the bar code 530 and credits the game prize device 610 1 through 610 N accordingly. Once the credits are made available to the player, the device voids the ticket and remits it to the player. Alternatively, the game device may retain the ticket in a storage area which is emptied routinely. Each game device 610 1 through 610 N also incorporates a player tracking lottery card reader which reads a lottery issued player tracking card for tracking the player=s play. In this non casino system, points are accumulated based on play and then redeemed for cash or prizes.

To participate in the lottery loyalty system, players register by providing personal information in return for their player tracking lottery card. Like casino player tracking cards, the lottery card is used to track play and generate points based thereon. The accumulated points are redeemable by the player for cash and other prizes offered by the lottery. Players may check their accumulated point totals via the game device 610 1 through 610 N or via a personal computer in communication with a lottery website. This system encourages players to purchase the scratch off tickets and provides the players with a unique entertainment vehicle (e.g., prize game device) to amass prizes. Lotteries benefit by gathering lottery player information which is used to market to specific players or groups of players. Heretofore, lotteries have had no accurate method for determining demographic profiles of scratch off ticket players.

Game device outcomes are pre determined based on the specific scratch off ticket inserted into the game device 610 1 through 610 N. In other words, the central computers or servers 620 store a scratch off ticket matrix defining the pre-established game device outcomes for each scratch off ticket in a series. Therefore, the number of points accumulated by the player is directly related to the specific scratch off ticket which is inserted into the device 610 1 through 610 N. In this manner, the lottery can pre determine its hold and manage prize inventory directly or through a third party as disclosed below. It is also envisioned that in one embodiment of the loyalty program the theme of a particular series of scratch off tickets will match the theme of the game devices 610 1 through 610 N and available prize options.

The game devices 610 1 through 610 N are ideally multi game devices which provide players with a choice of games to play. Moreover, the game devices 610 1 through 610 N are patterned after casino style game devices to afford the player a maximum level of excitement and familiarity. The game devices 610 1 through 610 N may also be in the form of video lottery terminals. In any arrangement, games are distributed by the central computer or server 620 to the game devices 610 1 through 610 N as selected by the player. The games may also be stored directly on each device 610 1 through 610 N. Alternative configurations may also be employed without departing from the spirit and scope of the embodiments of the present invention.

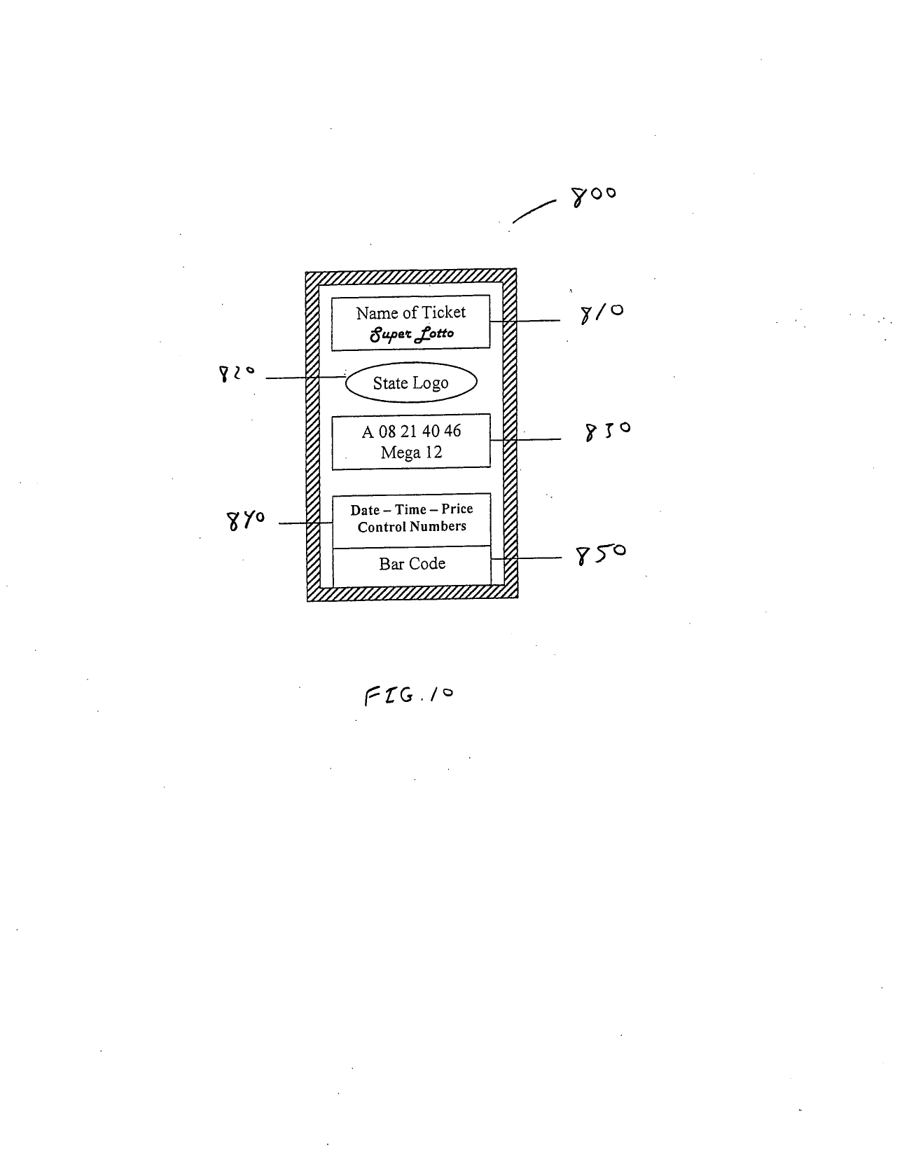

FIG. 9 shows a fulfillment system utilizing a third party to handle the distribution of prizes ordered by players which have accumulated the requisite number of lottery loyalty points. Prizes may be ordered from a clearing house 650 via a play game device 610, Internet website 670 or order form 680. Clearing house personnel also have access to the player tracking system 690 and state lottery 700 (and vice versa) in order to verify and ensure adjustment of player point totals. Upon receiving and verifying a player order, the clearing house 650 communicates the same to the fulfillment company 710 which distributes the ordered prize to the appropriate player 720. The lottery may also act as its own clearing house and/or fulfillment company for distributing prizes, but the use of a third party lessons the lottery=s workload.

The lottery benefits of the loyalty program include the ability to compete with local casinos, the ability to market much more broadly and the ability to increase revenues. Player benefits comprise the entertainment value associated with playing the game devices and increased chances of winning based on the increased sales of tickets by the lottery. Retailers benefit by increasing revenue based on providing access to game devices and selling more lottery tickets. Accordingly, the lottery may monitor the play at each provider location and reward locations for certain levels of play.

In a third embodiment, non winning or winning online tickets are redeemed for play at expressly dedicated devices. Such an online lottery ticket is shown in FIG. 10. The ticket 800 includes a ticket name 810, state logo 820, player or randomly selected lottery numbers 830, ticket data 840 and a bar code or other marking 850. The online tickets are dispensed through a network of linked devices controlled by the lottery. Typically, convenience stores, gas stations, grocery stores and similar outlets act as agents for the lottery and operate the linked devices and dispense the lottery tickets to the public.

By way of example, Mega Millions is a pooled lottery game including ten states, namely Georgia, Illinois, Maryland, Massachusetts, Michigan, Virginia, New Jersey, Ohio, New York and Washington. Such pooled online lotteries generate enormous jackpots which encourage large sales of tickets (i.e., more than one billion tickets are sold each year). Of the large number of online tickets sold each year, a majority are losing tickets. To date losing online tickets are little more than trash. However, the third embodiment of the present invention creates value for losing lottery tickets. By allowing losing online tickets to be redeemed at a game device, players are given a second chance to win a prize.

The third embodiment is facilitated by game devices, such as slot machines, placed in casinos throughout the state or states conducting the online lottery. The game devices read the non winning tickets, and in some instances winning tickets, and provide credits for play or bonus play. Besides accepting the non winning tickets, the devices also accept cash or its equivalent for normal casino play. Ideally, the state linked game devices are promoted in conjunction with the corresponding lottery. That is, in the present example the linked game devices may be promoted under the name Mega Millions for quick reference by both lottery and slot machine players. Such a system may be facilitated by both online tickets and scratch off lottery tickets.

In this system, cash play of the linked game devices facilitates a wide area progressive jackpot. Accordingly, for each dollar played in each linked device a certain percentage (e.g., 2.5%) is dedicated to a progressive jackpot. Such progressive jackpots become very large and, therefore, very popular. To encourage play, the ever changing progressive jackpot amount is prominently displayed on a large sign or monitor above the subject devices. In addition, the sign or monitor may display the amount of the online lottery.

While the non winning ticket redemption may take many forms, in one specific example, play is limited to certain criteria. Accordingly, non winning tickets may only be redeemed during specified or randomly selected bonus time periods. Moreover, to redeem the non winning tickets players must be playing the device using cash prior to the specified or randomly selected time period. The criteria encourage holders of non winning lottery tickets to play the game devices in a normal fashion in order to then redeem their non winning lottery tickets during the specified or randomly selected time periods. Upon the start of the time period, active players may be provided with a limited or unlimited number of free plays during the time period. The amount of free play is related to the non-winning lottery tickets redeemed at the game device.

In this system, the sign or monitor may also display a non winning ticket jackpot. The non winning ticket jackpot may be generated, like the progressive jackpot, using a small percentage (0.5%) of each dollar played in each linked device. The non-winning ticket jackpot is dedicated to those players playing on bonus time related to redeemed non-winning lottery tickets.

Although the invention has been described in detail with reference to several embodiments, additional variations and modifications exist within the scope and spirit of the invention as described and defined in the following claims.

I claim:

1. A scratch off lottery ticket comprising:
a first ticket portion sponsored by a lottery, said first portion including a game of chance; and
a second ticket portion sponsored by a non lottery party, said second portion including potential prize giveaways associated with the business of the non lottery party.

2. The lottery ticket of claim 1 wherein the non lottery party is a casino.

3. The lottery ticket of claim 2 wherein the potential prize giveaways include one or more of the potential prizes in the group consisting of cash prizes, free casino play and discounted or free casino amenities.

4. The lottery ticket of claim 3 wherein the ticket further comprises a bar code readable by a game device such that the free casino play may be redeemed by inserting the portion of said ticket including said bar code into said game device.

5. The lottery ticket of claim 1 further comprises a perforation for separating the first and second ticket portions from one another.

6. A scratch off lottery ticket comprising:
a first section for providing a game of chance wherein game prizes are redeemed through a lottery system; and
a second section for offering rewards associated with a non lottery entity wherein said rewards are redeemed at a location operated by the non lottery entity location.

7. The scratch off lottery ticket of claim 6 further including a means for separating the first section from the second section.

8. The scratch off lottery ticket of claim 7 wherein the means for separating the first section from the second section is a perforation.

9. The scratch off lottery ticket of claim 6 wherein the non lottery entity is a casino.

10. The scratch off lottery ticket of claim 9 wherein the rewards comprise free casino play, drawings for cash, and discounted or free casino amenities.

11. The scratch off lottery ticket of claim 10 further comprising a bar code readable by a casino game device such that the free play is redeemed by inserting said bar code portion of said ticket into said game device.

12. A scratch off lottery ticket comprising:
a first section offering a game of chance; and
a second section offering game device credits.

13. The scratch off lottery ticket of claim 12 further comprising a bar code readable by a game device such that said device credits are redeemed by inserting the portion of said ticket including said bar code into said game device.

14. A scratch off lottery ticket system comprising:
a scratch off lottery ticket having a section offering game device credits, said ticket further having a bar code; and
a plurality of networked game devices, each said game device having a bar code or optical reader for receiving at least said bar code portion of said ticket for automatically dispensing said credits to said game device.

15. The system of claim 14 further comprising player tracking cards readable by a card reader integrated into each game device.

16. The system of claim 15 wherein players accumulate points based on play, said accumulated points redeemable for prizes.

17. The system of claim 15 wherein players accumulate points based on play wherein said points are pre established and directly related to the specific scratch off ticket inserted into said game device.

18. The system of claim 14 further comprising one or more central servers linked with each game device.

19. The system of claim 18 wherein the one or more central servers store and distribute games to the game devices.

20. The system of claim 14 wherein the networked game devices are each located in a state which manages the system.

21. The system of claim 14 wherein each game device offers a player a selection of multiple games.

22. A method of conducting a scratch off lottery ticket program comprising:
providing scratch off lottery tickets offering at least a game device credit prize; providing one or more game devices, each device including means for acquiring a number of winning game device credits from said lottery tickets and causing any winning game device credits to be placed on said game device;
providing means for tracking play of said one or more game devices; awarding player points based on the tracked play; and
offering prizes in return for accumulated points.

23. The method of claim 22 wherein the means for tracking play comprises a player tracking card.

24. The method of claim 22 wherein the ticket comprises a first section dedicated to a game of chance and a second section dedicated to offering the game device credits.

25. The method of claim 22 wherein the one or more game devices are video lottery terminals.

26. The method of claim 22 wherein the one or more game devices are linked to one another.

27. The method of claim 22 wherein each game device is linked to a central computer or central server.

28. The method of claim 27 wherein the central computer or central server stores games and provides them to the game device upon a player selection.

29. The method of claim 22 wherein the means for acquiring the number of winning game device credits from said lottery tickets is a bar code reader or optical reader.

30. A method of conducting a lottery ticket program comprising:
providing one or more game devices, each game device including a means for acquiring information from lottery tickets; and
providing bonus play on the one or more game devices in response to the one or more game devices acquiring the information from the lottery tickets.

31. The method of claim 30 wherein the means for acquiring the information is a bar code reader or optical reader.

32. The method of claim 30 wherein the bonus play is provided during pre established time intervals.

33. The method of clam 30 wherein the bonus play is provided during randomly selected time intervals.

34. The method of claim 30 wherein the bonus play is provided for only non winning lottery tickets.

35. The method of claim 30 further comprising providing a progressive jackpot corresponding to only non winning lottery tickets.

36. The method of claim 30 wherein the one or more game devices are slot machines.

37. A game device comprising:
means for acquiring information from a lottery ticket wherein said acquired information is used to determine an amount of bonus play; and
means for providing said bonus play during limited time intervals.

38. The game device of claim 37 wherein the limited time intervals are pre established or randomly established.

39. The game device of claim 37 wherein the means for acquiring information is a bar code reader or optical reader.

40. The game device of claim 37 wherein the means for providing the bonus play during select time intervals comprises at least a device processor.
